(19) United States
(12) Patent Application Publication
(10) Pub. No.: US 2020/0224900 A1
(43) Pub. Date: Jul. 16, 2020

(54) AIRFLOW SYSTEM WITH TEMPERATURE AND HUMIDITY CONTROL

(71) Applicant: ELIGHTS AGRICULTURAL TECHNOLOGY CO., LTD., HSINCHU CITY (TW)

(72) Inventor: YING-KAI LEE, BEIJING (CN)

(21) Appl. No.: 16/583,562

(22) Filed: Sep. 26, 2019

(30) Foreign Application Priority Data
Jan. 16, 2019 (TW) 108101578

(51) Int. Cl. F24F 11/00; F24F 1/0358; F24F 11/755; A01G 9/24

(52) U.S. Cl. CPC F24F 11/0008; F24F 1/0358; F24F 2006/001; A01G 9/246; F24F 11/755

(57) ABSTRACT

An airflow system with temperature and humidity control is provided, comprising a cyclic regeneration unit, at least one air supply unit and at least one air return unit. The humidity and temperature of the air circulating inside the system is adjusted via the cyclic regeneration unit. By designing angles of the air output from the air supply unit, it forms turbulence. And, the air returns back to the cyclic regeneration unit via the air return unit. In order to form the turbulent flow efficiently within an enclosed space, an air supply channel does not overlap with an air return channel orthographically, and pressure of the air exiting from the air supply channel is higher than that flowing into the air return channel such that pressure of the enclosed space is positive for preventing outside air flows into the enclosed system and affecting the humidity and temperature of the system.

This application claims priority for Taiwan patent application no. 108101578 filed on Jan. 16, 2019, the content of which is incorporated by reference in its entirely.

### BACKGROUND OF THE INVENTION

### Field of the Invention

The present invention relates to an air flow system, and more particularly to an airflow system with temperature and humidity control.

### Description of the Prior Art

Due to the impact of climate and extreme weather changes, the yield and quality of vegetables, fungi and other plants cultivated in traditional greenhouses have been declining. Among the recent years, a certain kind of greenhouse system employing water curtain cultivation has been utilized to overcome the effects on cultivation involved with climates. The system mainly uses the water curtain apparatus to lower the temperature. Through the principle of cold and heat exchange, the honeycomb material is installed in the air inlet, so the water flows down from the above mentioned honeycomb material to form a water curtain. On the other side of the greenhouse is settled with a fan. The negative pressure generated by the fan causes the air outside to be drawn in, passed through the water curtain, and finally enters the interior of the greenhouse. Therefore, when the air outside having high temperature and low humidity passes through the water curtain, the air is adjusted to become with low temperature and high humidity by the latent heat of vaporization absorbed by the water, such that the environment can be suitable for fungi to grow.

However, the humidity in the greenhouse relies only on the temperature and humidity exchange between the water curtain and the exterior air. In addition, the fan in this system causes the air circulation inside the greenhouse to be accelerated, which in turn causes the humidity inside the greenhouse to decrease. As a result, the overall humidity of the greenhouse cultivation system using water curtain can be merely 65%-75%, and such level of humidity are quite far from meeting the humidity requirements of fungus planting. Therefore, the conventional greenhouse cultivation system usually needs to be further supplemented with artificial moisturizing means. Under normal circumstances that when the fan is used, an extra humidifier in the greenhouse must be turned on to ensure and maintain an expected humidity.

Therefore, on account of above, to overcome the above mentioned problems, it should be obvious that there is indeed an urgent need for the professionals in the field for a new airflow system with temperature and humidity control to be developed that can effectively overcome the effects on plants cultivation owing to climates and extreme weather changes in the prior design.

### SUMMARY OF THE INVENTION

In order to overcome the abovementioned disadvantages, one major objective in accordance with the present invention is provided for an airflow system with temperature and humidity control. The airflow system can be disposed in a greenhouse or a container so as to provide an air flow having expected temperature and humidity for an enclosed space. Meanwhile, it is advantageous to make the proposed airflow system with temperature and humidity control moveable by integrating it with the container.

Another objective of the present invention is to dispose an air return unit at the bottom of the enclosed space. Compared to an air supply unit, the air return unit is at the periphery instead of center of the enclosed space. Therefore, when the air exits from the air supply unit, the air flow is able to induce much more turbulence by arranging where the air supply unit and the air return unit should be located such that the humidified air is evenly distributed in the space and maintains the same humidity.

And yet another objective of the present invention is to make the air flow spontaneously from turbulence by disposing the air supply unit and the air return unit properly.

For achieving the above mentioned objectives, the present invention discloses an airflow system with temperature and humidity control adapted to provide an air to recycle therein. The system comprises a cyclic regeneration unit, at least one air supply unit and at least one air return unit. The cyclic regeneration unit includes an air supply vent and an air return vent, wherein a temperature control part and a humidity control part are respectively disposed between the air supply vent and the air return vent. The temperature control part is used for maintaining temperature of the air within a temperature range, and the humidity control part is used for maintaining humidity of the air within a humidity range.

The air supply unit includes an air supply channel, a plurality of first air outlets and a plurality of second air outlets, wherein the air supply channel includes an air inlet connected with the air supply vent of the cyclic regeneration unit. The air flows into the air supply channel of the air supply unit from the cyclic regeneration unit and exits from the first air outlets and the second air outlets. The air flowing in the air supply channel has a main flow direction, the air exits from the first air outlets in a first direction and exits from the second air outlets in a second direction. At least one of the first direction and the second direction is adjustable.

The air return unit includes an air return channel and a plurality of air return inlets, wherein the air return unit is physically disposed below the air supply unit. The air return inlets receive the air exiting from the first air outlets and the second air outlets. The air return channel includes an air outlet connected with the air return vent of the cyclic regeneration unit, and the air flows into the cyclic regeneration unit from the air return channel of the air return unit, wherein, the air supply channel does not overlap with the air return channel orthographically, and pressure of the air exiting from the air supply channel is higher than that of the air flowing into the air return channel.

The proposed airflow system with temperature and humidity control disclosed in the present invention is employed for making the air flow from turbulence spontaneously by disposing the air return unit on both sides below the air supply unit after the air exits from the air supply unit, such that humidified air can be evenly distributed in the space and maintains the same humidity.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a schematic structural diagram of an airflow system with temperature and humidity control in accordance with an embodiment of the present invention.

FIG. 2 shows a schematic flow diagram of an airflow system with temperature and humidity control in accordance with an embodiment of the present invention.

FIG. 3 shows a schematic structural diagram of an airflow system with temperature and humidity control being applied to a container in accordance with an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

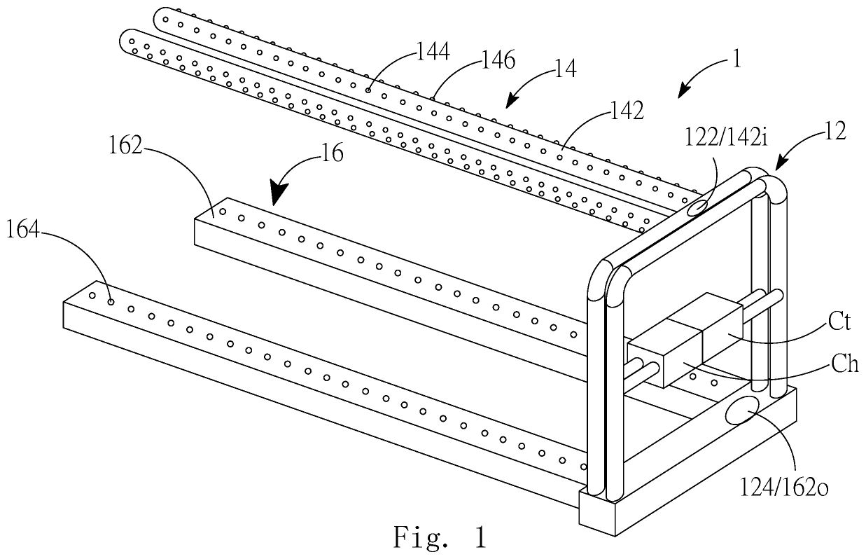

Please refer to FIG. 1, which shows a schematic structural diagram of an airflow system with temperature and humidity control in accordance with an embodiment of the present invention. The airflow system with temperature and humidity control 1 of the present invention is adapted to provide an air to recycle therein. According to the present invention, the airflow system with temperature and humidity control 1 comprises a cyclic regeneration unit 12, at least one air supply unit 14 and at least one air return unit 16. The cyclic regeneration unit 12 includes an air supply vent 122 and an air return vent 124, and a temperature control part Ct and a humidity control part Ch are respectively disposed between the air supply vent 122 and the air return vent 124. The temperature control part Ct is used for maintaining the temperature of the air within a temperature range. The humidity control part Ch is used for maintaining the humidity of the air within a humidity range. The air supply unit 14 includes an air supply channel 142, a plurality of first air outlets 144 and a plurality of second air outlets 146. The air supply channel 142 includes an air inlet 142i, which is connected with the air supply vent 122 of the cyclic regeneration unit 12. The air flows into the air supply channel 142 of the air supply unit 14 from the cyclic regeneration unit 12, and exits from the first air outlets 144 and the second air outlets 146. The air flowing in the air supply channel 142 has a main flow direction, and the air exits from the first air outlets 144 in a first direction and exits from the second air outlets 146 in a second direction, wherein at least one of the first direction and the second direction is adjustable. The air return unit 16 includes an air return channel 162 and a plurality of air return inlets 164. The air return unit 16 is physically disposed below the air supply unit 14. The air return inlets 164 receive the air exiting from the first air outlets 144 and the second air outlets 146. The air return channel 162 includes an air outlet 162o, which is connected with the air return vent 124 of the cyclic regeneration unit 12. The air flows into the cyclic regeneration unit 12 from the air return channel 162 of the air return unit 16. According to the embodiment of the present invention, the air supply channel 142 does not overlap with the air return channel 162 orthographically. Meanwhile, the pressure of the air exiting from the air supply channel 142 is higher than the pressure of the air flowing into the air return channel 162.

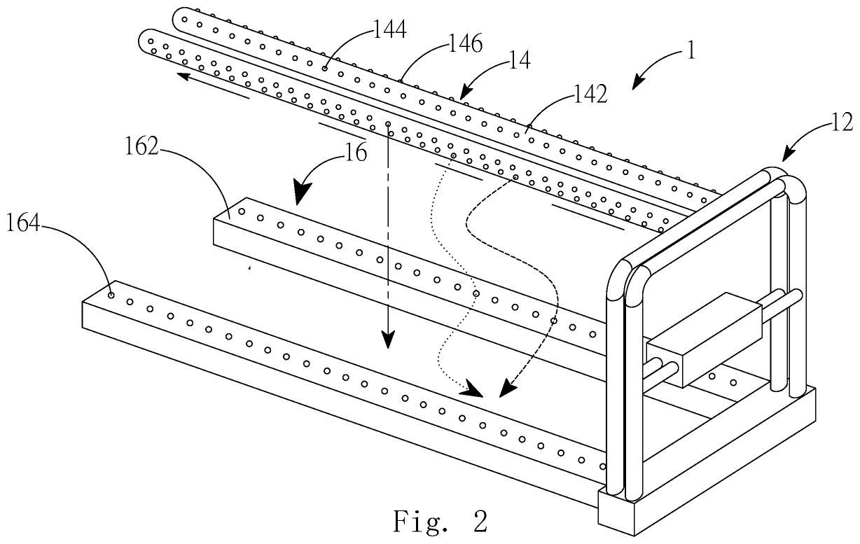

According to the embodiment of the present invention, the above mentioned first direction is perpendicular to the main flow direction, but different from the second direction. For example, when the air supply channel 142 is disposed horizontally, the main flow direction of the air is along the air supply channel 142. Please refer to FIG. 2, the main flow direction of the air is indicated by the long dashed line in the figure, and the first direction which is perpendicular to the main flow direction is indicated by the long and short dash line in the figure, which is in the direction of the vertical downward direction. In order to make the air flow spontaneously forming an obvious turbulence, the second direction can be perpendicular to the first direction but different from the main flow direction, as indicated by the short dashed line in the figure. Alternatively, an angle can be further configured between the second direction and the first direction, while the first and second directions are still different from the main flow direction, as shown by the dotted line indicating the second direction in the figure.

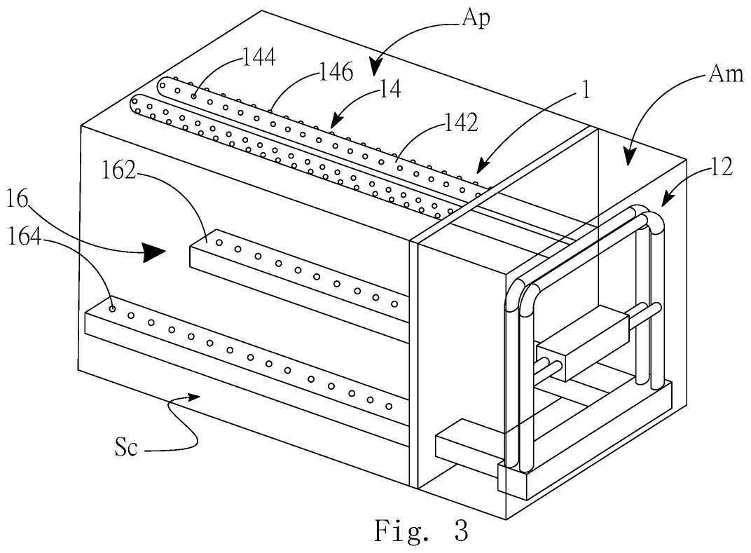

Moreover, please refer to FIG. 3, the airflow system with temperature and humidity control 1 of the present invention is disposed in an enclosed space Sc, which can be for example, a greenhouse or a container. In such an embodiment, a 40-inch container is taken as an example. The length of the container is about 12 meters having the width and the height each about 2.3 meters. As a result, the entire airflow system with temperature and humidity control 1 of the present invention has a length of about 12 meters, and a distance which is approximately within 2 meters exists between the air supply unit 14 and the air return unit 16. According to the embodiment, such distance is sufficient for the air to spontaneously form an obvious turbulence before flowing into the air return inlets 164 of the air return channel 162 from the first air outlets 144 and second air outlets 146 of the air supply channel 142.

In addition, since the temperature control part Ct and the humidity control part Ch are provided in the cyclic regeneration unit 12 so as to adjust the temperature and humidity of the air returning back to the cyclic regeneration unit 12, reactions of heat exchange as well as humidity exchange arise in the cyclic regeneration unit 12. Moreover, in order to ensure that the pressure of the air transmitted to the air supply unit 14 can be maintained within a certain pressure range, a pressurizing part (not shown) can be further disposed in the cyclic regeneration unit 12 to supercharge the air. Due to a variety of above mentioned treatments applied to the air, additional heat energy is usually generated in the neighboring region of the cyclic regeneration unit 12. To avoid affecting the temperature and humidity control effect of the airflow system with temperature and humidity control 1 of the present invention, division plates or other structures may be further employed for separating a fan area Am and a planting area Ap in the enclosed space Sc, wherein the fan area Am is mainly provided with the cyclic regeneration unit 12, and the planting area Ap is mainly provided with the air supply unit 14 and the air return unit 16. From the above, it is apparent that the apparatus for carrying planting and cultivating are disposed in the planting area Ap, and the planting area Ap is also the area where the turbulence mostly arises.

The above-mentioned pressurizing part is able to provide the pressure of the air to have a pressure range, which is mainly capable of maintaining the pressure required for the air to flow through the air supply unit 14. Taking the airflow system with temperature and humidity control in FIG. 3 as an example, since the airflow system with temperature and humidity control 1 is installed in the container, the air pressure supplied by the pressurizing part must be large enough to allow the air to flow to the end of the air supply unit 14 after exiting from the cyclic regeneration unit 12. That is to say, the air must be able to flow a length of 12 meters under a certain air pressure. Generally, regardless of the length of the air supply unit 14, the pressure gradient in the air supply channel 142 of the air supply unit 14 is not greater than 300 pa so as to ensure that the air is able to have sufficient flow kinetic energy in the air supply channel 142. Otherwise, the air in the planting area Ap may have grater flow rate in the area closed to the fan area Am than the flow rate in the area far away from the fan area Am, which induces an unbalanced air circulation in return.

According to the proposed airflow system with temperature and humidity control 1 disclosed in the present invention, the materials of the cyclic regeneration unit 12, the air supply unit 14, and the air return unit 16 comprises polymer materials or metal.

In view of the above, the present invention discloses an airflow system with temperature and humidity control that spontaneously provides turbulence by air convection, and meanwhile avoids generation of large volume airflow by designing a plurality of air outlets which are disposed densely and tiny. Objectives of controlling the temperature and humidity of the air precisely are accomplished. Also, excessive wind speed is avoided. The strong winds are dispersed so that the humidified water molecules will not be easily blown off, thus effectively maintaining the enclosed space to have high humidity, which solves the contradiction between humidification and cooling in the general conventional airflow systems.

The embodiments described above are illustrated to demonstrate the objectives, technical contents and advantages of the present invention. However, it shall be noticed that, the above mentioned only shows exemplary embodiments of the present invention, and is not intended to limit the scope of the present invention.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An airflow system with temperature and humidity control adapted to provide an air to recycle therein, comprising:
a cyclic regeneration unit, including an air supply vent and an air return vent, wherein a temperature control part and a humidity control part are respectively disposed between the air supply vent and the air return vent, the temperature control part is used for maintaining temperature of the air within a temperature range, and the humidity control part is used for maintaining humidity of the air within a humidity range;
at least one air supply unit, including an air supply channel, a plurality of first air outlets and a plurality of second air outlets, wherein the air supply channel includes an air inlet connected with the air supply vent of the cyclic regeneration unit, the air flows into the air supply channel of the air supply unit from the cyclic regeneration unit and exits from the first air outlets and the second air outlets, the air flowing in the air supply channel has a main flow direction, the air exits from the first air outlets in a first direction and exits from the second air outlets in a second direction, and at least one of the first direction and the second direction is adjustable; and
at least one air return unit, including an air return channel and a plurality of air return inlets, wherein the air return unit is physically disposed below the air supply unit, the air return inlets receive the air exiting from the first air outlets and the second air outlets, the air return channel includes an air outlet connected with the air return vent of the cyclic regeneration unit, and the air flows into the cyclic regeneration unit from the air return channel of the air return unit;
wherein, the air supply channel does not overlap with the air return channel orthographically, and pressure of the air exiting from the air supply channel is higher than that of the air flowing into the air return channel.

2. The airflow system with temperature and humidity control according to claim 1, wherein the cyclic regeneration unit further comprises a pressurizing part to ensure pressure of the air within a certain pressure range.

3. The airflow system with temperature and humidity control according to claim 1, wherein the first direction is perpendicular to the main flow direction, but different from the second direction.

4. The airflow system with temperature and humidity control according to claim 1, wherein the first direction is perpendicular to the second direction, but the first direction and the second direction are different from the main flow direction.

5. The airflow system with temperature and humidity control according to claim 1, wherein an angle is further configured between the second direction and the first direction, while the first direction and the second direction are different from the main flow direction.

6. The airflow system with temperature and humidity control according to claim 1, wherein a distance exists between the air supply unit and the air return unit, and the distance is sufficient for the air to form turbulence before flowing into the air return inlets from the first air outlets and the second air outlets.

7. The airflow system with temperature and humidity control according to claim 1, wherein materials of the cyclic regeneration unit, the air supply unit and the air return unit comprises polymer materials or metal.

8. The airflow system with temperature and humidity control according to claim 1, wherein pressure gradient of the air in the air supply channel of the air supply unit is not greater than 300 pa.

9. The airflow system with temperature and humidity control according to claim 1, being disposed in an enclosed space.

10. The airflow system with temperature and humidity control according to claim 9, wherein the enclosed space further comprises a fan area and a planting area, the fan area is mainly provided with the cyclic regeneration unit, and the planting area is mainly provided with the air supply unit and the air return unit.

11. The airflow system with temperature and humidity control according to claim 9, wherein the enclosed space is a greenhouse or a container.
